(19) United States
(12) Patent Application Publication
(10) Pub. No.: US 2008/0196639 A1
(43) Pub. Date: Aug. 21, 2008

(54) INTRODUCTION OF CYANIDE WASTE AS A NOX REDUCTANT

(75) Inventor: David Long, Fullerton, CA (US)

Correspondence Address: Rutan & Tucker, LLP., 611 ANTON BLVD, SUITE 1400, COSTA MESA, CA, 92626, US

(73) Assignee: Cement Industry Environmental Consortium, Riverside, CA (US)

(21) Appl. No.: 11/949,628

(22) Filed: Dec. 3, 2007

Related U.S. Application Data
(63) Continuation of application No. 10/507,146, filed on Apr. 27, 2005.
(60) Provisional application No. 60/311,024, filed on Aug. 8, 2001.

(51) Int. Cl. F23J 15/02; B01D 53/56

(52) U.S. Cl. 110/203; 423/235

(57) ABSTRACT

The present invention is directed to systems and methods of reducing nitrogen oxides from an air stream by introducing cyanide into the air stream and reacting the cyanide with the nitrogen oxides. In some embodiments, the reacting takes place at a temperature between 1200 and 1640° F.

This application claims the benefit of U.S. provisional application number 60/311024 titled “Thermal Destruction of Cyanide Wastes as a NOx Control Mechanism” filed on Aug. 8, 2001 incorporated herein by reference in its entirety.

### FIELD OF THE INVENTION

The field of the invention is waste recycling.

### BACKGROUND

NOx is the term used to refer to a family of air polluting chemical compounds. Of the NOx compounds, only nitrogen dioxide (NO₂) is regulated by the Environmental Protection Agency (EPA). NO₂ is not only an air pollutant by itself, but it also reacts in the atmosphere to form ozone (O₃) and acid rain. While stratospheric ozone offers protection against radiation from the sun, it is desirable to minimize tropospheric ozone in the ambient air we breathe, as tropospheric ozone is a primary constituent of smog. The EPA has established National Ambient Air Quality Standards (NAAQS) for NO₂, and tropospheric ozone. Furthermore, acid rain may have detrimental effects on the ecosystem.

NOx typically results from the combustion of certain fuels. Automobiles and power plant boilers are two primary sources of NOx, however, substantial amounts of NOx are released by waste incinerators, iron and steel mills, glass manufacturers, petroleum refineries, and cement manufacturers to name a few. In particular, the burning of coal during a cement manufacturing process is likely to result in the production and release of NOx.

U.S. Pat. No. 4,154,803 to Uchikawa et al. (May 1979) teaches a method of decreasing the content of nitrogen oxides in a combustion exhaust gas by mixing the gas with a reagent material selected from an ammonia, an ammonium salt, urea, and an aqueous solution thereof. Through selective non-catalytic reduction, the ammonia or other material reduces the NOx to water vapor and atmospheric nitrogen. The '803 patent specification further describes performing this method on a flue gas evolved during the baking of cement. U.S. Pat. No. 4,307,068 to Matsumoto et al. (December 1981) also teaches methods for treating an exhaust gas containing nitrogen oxide by adding ammonia to the exhaust gas. While the introduction of ammonia and some other materials may reduce the ratio of NOx in the exhaust, such a process is generally only effective in a narrow temperature range (1073K-1373K), and is often not a feasible alternative due to its cost.

In order to reduce the cost of cement manufacturing, it is known to use waste products to contribute mineral content to the cement. U.S. Pat. No. 5,496,404 to Price and Long (March 1996) teaches that waste paint can be used in the manufacture of Portland cement. The waste paint is added to the process after burning the raw materials. During the burning process, the raw materials become chemically attached and partially fused forming lumps of cement clinker. These lumps are usually finely ground to form Portland cement, and it is during this grinding step that the '404 patent contemplates addition of the waste materials. In this case, the mineral content of the waste may provide benefit to the Portland cement. A limitation with respect to adding the waste during the grinding is that only a small number of materials are usable at this point. The usable materials are generally limited to high calcium/low silica materials.

A further use for waste materials in the manufacture of cement incorporates high fuel value wastes that contribute heat to the burning process. Generally, raw materials are burned in a kiln, and this burning process may be calcining, roasting, autoclaving or some other process, but in any case, the process is generally performed at about 2600 degrees Fahrenheit. U.S. Pat. No. 4,081,285 to Pennel (March 1978) teaches that high fuel value waste such as oil based paint may be burned outside of the kiln as an aid to reaching the required temperature. Still, there is a need to find wastes that can reduce NOx emissions associated with the production of cement.

One such waste that has been used to reduce NOx is waste water sludge. In U.S. Pat. No. 5,586,510 to Leonard et al. (December 1996) aqueous sludge from waste water is introduced into a kiln to reduce the ratio of NOx in an exhaust gas produced during a cement manufacturing process. Using a waste product to reduce NOx has a dual benefit in that it helps the environment and is generally less expensive, however there is a need to be able to use other waste materials including non-aqueous waste materials to effectively denitrify flue gases.

An alternative method of removing nitrogen oxides from gas produced by cement manufacture involves using solid waste material as taught in U.S. Pat. No. 62100154 to

Evans et al. (April 2001). The '154 patent describes methods of reducing NOx by introducing waste tyres into the manufacturing process at a point between the mineral inlet end of the rotary kiln and the lowermost cyclone of a pre-heater system. It is further taught that the waste tyres are in contact with hot gas for a sufficient period of time to reduce the weight of the volatile combustible content of the tyres by at least 30%.

There is an ongoing need to find materials and methods of using those materials that aid in the production of cement as well as decrease the amount of harmful NOx released into the atmosphere during various processes.

### SUMMARY OF THE INVENTION

The present invention is directed to systems and methods of reducing nitrogen oxides from an air stream by introducing cyanide into the air stream and reacting the cyanide with the nitrogen oxides. In some embodiments, the reacting takes place at a temperature between 1200 and 1640° F.

It should be appreciated that the inventive subject matter is especially useful for a cement manufacturing process in which cyanide containing waste material is added to the process in order to both reduce NOx and provide mineral content.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a block diagram of a method of reducing nitrogen oxides.

FIG. 2 is a schematic of a cement manufacturing system.

### DETAILED DESCRIPTION

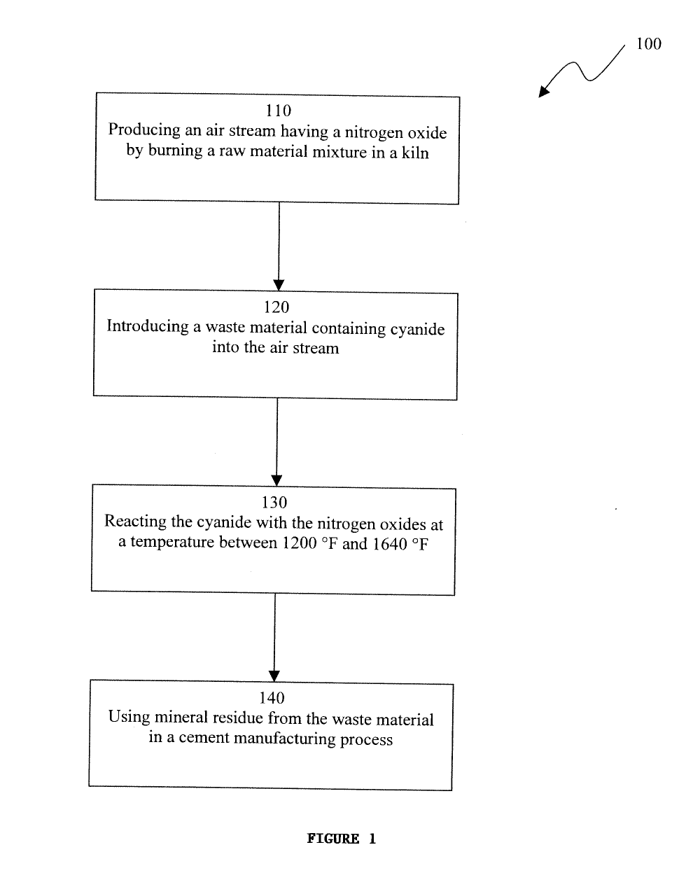

Referring first to FIG. 1, a method of reducing nitrogen oxides 100, includes the steps of producing an air stream having a nitrogen oxide by burning a raw material mixture in a kiln 110, introducing a waste material containing cyanide into the air stream 120 in a manner that causes the cyanide to react with nitrogen oxides in the air stream at a temperature between 1200° F. and 1640° F. 130, and using mineral residue from the waste material in a cement manufacturing process 140.

Nitrogen oxide (NOx) is a term that encompasses at least one of the following compounds: nitrous oxide (N₂O), Nitric Oxide (NO), dinitrogen dioxide (N₂O₂), dinitrogen trioxide (N₂O₃), nitrogen dioxide (NO₂), dinitrogen tetroxide (N₂O₄); and dinitrogen pentoxide (N₂O₅). An air stream having a nitrogen oxide is preferably a gas that has 200-1000 ppm of NOx, however, the concentration of NOx should not be interpreted herein as a limitation since reduction of NOx would occur with substantially higher or lower concentrations.

An air stream having a nitrogen oxide may be a flue gas resulting from a combustion process such as that which occurs during the burning of materials (e.g. limestone, silica, iron ore, and aluminum oxide) in a cement kiln. Generally, the combustion referred to here in is the combustion of a fuel, for example, coal, methane gas, oil, waste materials, and so on. In a typical cement manufacturing process the NOx laden gas is rises upward through a preheater tower and out an exhaust stack.

As the NOx laden gas rises, a waste material containing cyanide is introduced into the air stream 120. Cyanide is defined herein as any of various salts or esters of hydrogen cyanide containing a CN group, including potassium cyanide and sodium cyanide. Such cyanide containing waste may optionally be derived from mining operations that utilize a heap leach process. In a heap leach process, cyanide is percolated through the mined material, and as a result a waste material high in mineral content (e.g. iron, aluminum, and silica) is produced. The waste material, however, contains hydrogen cyanide which is itself a highly toxic compound. By using such waste a dual benefit may be achieved in that NOx concentration is reduced and desired mineral content is added. Cyanide containing waste is also a bi-product of an aluminum related process in which a “pot” comprising a steel shell lined with insulation material and a layer of carbon is used wherein the layer of carbon acts as the cathode for an electrolysis process. This process is discussed in detail in a co-pending application filed by the same inventor titled Use of Spent Potliners in Cement Production, and incorporated herein by reference in its entirety. It should be noted that under conditions in which moisture is present, ammonia (NH₃) may be produced from the spent potliner waste. Such ammonia may be used to additionally or alternatively aid in the reduction of NOx. Of course, cyanide-containing waste may be derived from other processes including an electroplating operation, and a chemical formulating operation.

It is preferred that the waste material be in a non-aqueous form, and introduction of a waste material containing cyanide 120 may occur with the aid of a blower that disperses the waste material into the air stream. Regardless of the mode for introducing the waste, sufficient mixing or intimate contact of the waste with the air stream is anticipated, and reacting of the cyanide with the nitrogen oxides 130 in a selective non-catalytic reduction (SNCR) may occur. It should be appreciated that while a SNCR process is preferred, it is contemplated that a selective catalytic reduction (SCR) process may also produced desired results.

In a preferred class of embodiments, reaction of the cyanide (i.e. the reagent) and the NOx occurs at a temperature between 1200° F. and 1640° F. At this preferred temperature range, the reduction of NOx has been shown to exceed that caused by ammonia. The temperature range within which reduction of NOx occurs should be interpreted broadly and as such reasonable variations in the temperature range may still yield a favorable result.

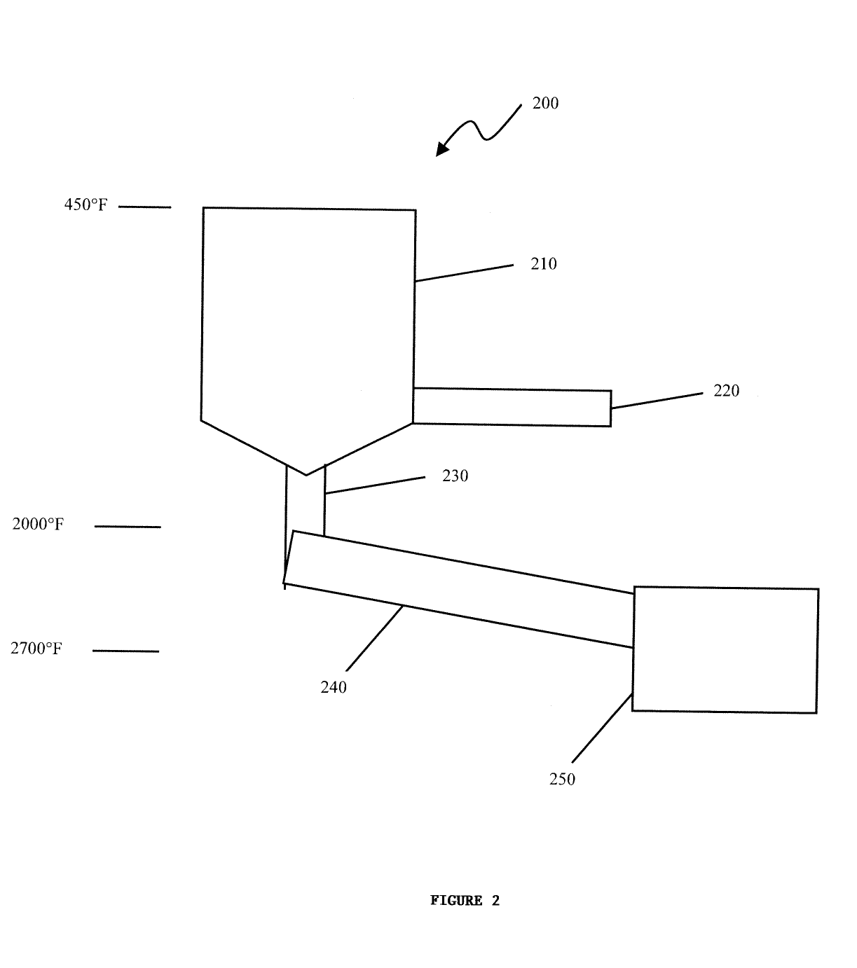

In FIG. 2, an exemplary cement manufacturing system 200 comprises a preheating and/or precalcining tower 210, a waste intake 220, a rising duct 230, a rotary kiln 240, and a clinker cooler 250. The relevant portion of the system begins with burning of raw materials in the kiln 240 where the temperature can reach 2700° F. or higher. Burning of the raw materials is accompanied by fuel combustion which generally produces NOx in the air stream in the kiln. The air stream generally follows a path from the kiln, up through the riser duct into the pre-heater tower 210 and then out an exhaust stack. At a suitable point in the path, a cyanide containing waste is introduced into the air stream through waste intake 220. A point in the path is suitable if the cyanide containing waste sufficiently mixes with a NOx laden air stream to cause reduction of the NOx. While introduction of the waste is depicted to occur directly into the pre-heater tower 210, it is contemplated that the waste intake 220 may be located at a point before the preheater tower 210 (i.e. the riser duct 230 or even the kiln 240) depending upon the temperature.

It is contemplated that factors, other than the temperature at which the waste is introduced, may affect the efficiency of NOx reduction. Among these factors are the concentration of oxygen in the air stream, retention time at appropriate temperatures, and intimacy of contact between the NOx reducing factors and NOx compounds.

Thus, specific embodiments and applications of Introduction of Cyanide waste as a NOx reductant have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of reducing nitrogen oxides from an air stream, comprising: directly introducing cyanide into the air stream at a temperature between 1200.degree. F. and 1700.degree. F.; and reacting the cyanide with the nitrogen oxides.

2. The method of claim 1, wherein the reacting step occurs at a temperature between 1200.degree. F. and 1640.degree. F.

3. The method of claim 2, wherein the cyanide is contained in a waste material.

4. The method of claim 3, wherein the waste material comprises ammonia.

5. The method of claim 3, wherein the nitrogen oxides are produced by a cement manufacturing process.

6. The method of claim 5, further comprising the step of producing the air stream at least in part by burning a raw material mixture in a kiln.

7. The method of claim 6, further comprising using mineral residue from the waste material as part of the cement manufacturing process.

8. A method of reducing nitrogen oxides released by a cement manufacturing process, comprising: burning a raw material mixture in a kiln thereby producing a gas comprising a nitrogen oxide compound; directly introducing a cyanide containing waste into the cement manufacturing process at a temperature between 1200.degree. F. and 1700.degree. F.; and reacting the cyanide containing waste with the gas oxides.

9. The method of claim 8, wherein the cement manufacturing process comprises a pre-heating step, and the cyanide containing waste is introduced during the pre-heating step.

10. The method of claim 9, wherein the step of reacting occurs during the pre-heating step.

11. The method of claim 10, wherein the step of reacting further occurs at a temperature between 1200.degree. F. and 1640.degree. F.

12. The method of claim 8, further comprising a step of deriving the cyanide containing waste from aluminum production.

13. The method of claim 12, wherein the cyanide containing waste further comprises ammonia.

14. The method of claim 8, further comprising the step of deriving the cyanide from a mining process.

15. The method of claim 8, wherein the nitrogen oxide compound is nitrogen dioxide.

16. The method of claim 8, further comprising a step of causing a reduction in the amount of the nitrogen oxide compound released from the cement manufacturing process.

17. A cement manufacturing system, comprising: a kiln that bums raw materials thereby producing a gas comprising a nitrogen oxide compound; a pre-heater tower coupled to the kiln; and a cyanide containing waste that is directly introduced into a pre-heater tower at a temperature between 1200.degree. F. and 1700.degree. F., such that the cyanide reacts with the gas to reduce the nitrogen oxide compound.

18. The system of claim 17, wherein the cyanide containing waste is derived from mining waste.

19. The system of claim 18, further comprising a waste input port to the pre-heater tower for introduction of the cyanide containing waste into the pre-heater tower.
